(19) United States
(12) Patent Application Publication
(10) Pub. No.: US 2012/0124922 A1
(43) Pub. Date: May 24, 2012

(54) SUPPORT SYSTEM FOR CARPORT WITH SOLAR PANELS

(75) Inventors: Paul R. Cusson, West Hartford, CT (US); Michael G. Greenamyer, Salem, OH (US); Bernard G. Petro, Campbell, OH (US); Thomas P. Kilar, JR., Boardman, OH (US); Robert J. Voytilla, Hubbard, OH (US)

(73) Assignee: Northern States Metals Company, West Hartford, CT (US)

(21) Appl. No.: 13/297,397

(22) Filed: Nov. 16, 2011

Related U.S. Application Data
(60) Provisional application No. 61/414,963, filed on Nov. 18, 2010.
(60) Provisional application No. 61/539,653, filed on Sep. 27, 2011.

(51) Int. Cl. F24J 2/52; E04H 12/18; E04D 13/18; B23P 19/04

(52) U.S. Cl. 52/173.3; 29/428; 52/655.1; 52/645

(57) ABSTRACT

A roof panel support system is supported by at least two structural beams, and includes a support matrix for panels, such as solar panels, that can constitute the roof of a structure. The support matrix includes panel rails that can hold panels installed from beneath the support matrix.

### PRIORITY INFORMATION

The present application claims priority to the following U.S. application Ser. Nos.: 12/383,240 filed Mar. 29, 2009; 12/567,908 filed Sep. 28, 2009; 12/686,598 filed Jan 13, 2010; 61/414,963 filed Nov. 18, 2010; 61/539,653 filed Sep. 27, 2011; and, 13/115,506 filed May 25, 2011, making reference to each in its entirety, and incorporating each herein.

### FIELD OF THE INVENTION

This invention relates to support systems for panel roofs and panel-like structures, such as solar energy collection systems, and more particularly to a support system for an array of photovoltaic panels, and a method of assembling the same for a variety of uses. The present invention includes a bi-directional matrix of upper and lower support members, including a variety of profiled upper panel rails arranged for adjustable attachment to lower support joists. Special panel holding devices, a reinforcement system and a method of assembly are also provided.

### BACKGROUND OF THE INVENTION

A standard photovoltaic (solar) panel array includes a plurality of solar panels optimally arranged for converting light incident upon the panels to electricity. Various support systems are used for attachment to roofs, free-field ground racks or tracking units. Typically, these support systems are costly, labor intensive to install, heavy, structurally inferior, and mechanically complicated. Placing the solar panels on the support structure can be very difficult, as can the wiring of the solar panels for array activation. Further, some large solar panels tend to sag and flex thereby rendering the panel mounting unstable.

Another major problem with mounting large solar panel arrays is that support structures (such as those described below) are required to support the weight of the panels and hold them steady so that all the operational features can be obtained. One popular location for solar panel arrays is provided by the roofs of various structures. Unfortunately, this means that a second structural arrangement (the solar panel support) is placed on the first structural arrangement (the roof). Very often this causes substantial stress on the original supports of the building. Even if such additional stress or load is not severe, the stacking of two non-reinforcing structural support arrangements on each other constitutes a waste in time and material.

One conventional panel support system generally includes off-the-shelf metal framing channels having a C-shaped cross-section, such as those sold under the trademarks UNISTRUT™ or BLIME™, improvised for use as vertical and horizontal support members. With reference to FIG. 3, photovoltaic (solar) panels 12 or other panel-like structures are directly secured to the support members and held in place by panel clips or panel holders (100, 100′, 120, 145, in a wide range of sizes and shapes). The panel clips serve as hold-down devices to secure the panel against the corresponding top support member in spaced-relationship. The clips are positioned and attached about the panel edges once each panel is arranged in place. This support system array is used with a free-field ground rack system.

For a conventional free-field ground rack system (for mounting solar panels) as shown in FIG. 1, vertical support elements, such as I-beams 14, are spaced and securely embedded vertically in the ground. Tilt mounting-brackets 16 are installed at the top of each I-beam, and each tilt mounting-bracket is secured to the I-beam such that a tilt bracket flange extends above the I-beam at an angle as best seen in FIG. 2A. As shown in this case, two UNISTRUT™ support joists 11, 13 span the tilt mounting-brackets 16 and are secured thereto. As seen in FIG. 2B, UNISTRUT™ mounting rails 15 are positioned across and fastened to the support joists 11, 13. To secure each rail to the corresponding horizontal joists, a bolt through a bolt hole made in the rail sidewall attaches to a threaded opening in a transverse nut-like plate slideably mounted inside the channel of the UNISTRUT™ joist 17, so that the nut-like plate engages and tightly secures against the upper flanges of the joist's C-channel 17 as seen in FIG. 2A. Importantly, the width of the plate is slightly less than the width of the channel, so that the plate can be slideably adjusted in the channel, without the plate rotating therein.

Once the bi-directional span 10 is assembled, each solar panel 12 is mounted by panel holding clips (100, 100′, 120, 145) which are secured to the support rails about the perimeter of each panel. An attachment portion of each panel clip is put in place, and secured using a fastener. This installation process is often costly, inaccurate, and time-consuming. The aforementioned ground-mount support arrangement cannot be used as part of another structure, such as a building roof.

Another example of a support system is shown in U.S. Pat. No. 5,762,720, issued to Hanoka et al., which describes various mounting-brackets used with a UNISTRUT™ channel. Notably, the Hanoka et al. patent uses a solar cell module having an integral mounting structure, i.e. a mounting-bracket bonded directly to a surface of the backskin layer of a laminated solar cell module, which is then secured to the channel bracket by bolt or slideably engaging C-shaped members. Other examples are shown in U.S. Pat. No. 6,617,507, issued to Mapes et al., U.S. Pat. No. 6,370,828, issued to Genschorek, U.S. Pat. No. 4,966,631, issued to Matlin et al., and U.S. Pat. No. 7,012,188, issued to Erling.

Notably, existing support systems require meticulous on-site assembly of multiple parts, performed by expensive, dedicated field-labor. Assembly is often performed in unfavorable working conditions, i.e. in harsh weather and over difficult terrain, without the benefit of quality control safeguards and precision tooling. Misalignment of the overall support assembly often occurs. This can jeopardize the supported solar panels or other supported devices. Further, wiring of the solar panels, once secured is also problematic.

The free-field ground rack system (including structural I-beams 14 and mounting-brackets 16) has two major drawbacks. The first is that such installations are costly. The second is that they require substantial space, very often when such is at a premium. Since many conventional roofs will not support a solar panel array, twice the ground space and twice the expense of a structural support arrangement is very often required to have both a building and a solar panel array.

To further complicate matter, proper spacing of the photovoltaic (solar) panels 12 is important to accommodate expansion and contraction due to the change of the weather. It is important, therefore, that the panels are properly spaced for maximum use of the bi-directional area of the span. Different spacing may be required on account of different temperature swings within various geographical areas. It is difficult, however, to precisely space the panels on-site using existing support structures without advanced (and expensive) technical assistance.

Even with a purpose-built installation to support a solar array (such as I-beams 14 and tilt mounting-bracket 16), and a two-dimensional array of support joists 11, 13 and mounting rails 15, placing individual solar panels 12 on the support structure can be problematical. Standard solar panels are heavy, awkward, and are conventionally held onto the support structures (support rail 15) using a wide variety of different mounting clips or panel holders (100, 105, 120, 145). The whole process of mounting solar panels 12 using the subject clips or panel holders is extremely awkward and somewhat risky to both the panels and the installation crew. This is especially true if the installation crew is not highly trained or experienced.

For example, with one of the existing designs described above (with reference to FIGS. 2A and 2B), until the upper panel rails are tightly secured to the lower horizontal joists, each rail is free to slide along the horizontal joists and, therefore, will need to be properly spaced and secured to be installed on-site. Further, since the distance between the two lower support joists must be fixed, it is preferable to drill the holes on-site, so that the lower support joists can be aligned to attach through the pre-drilled attachment holes of the tilt bracket 16. Unfortunately, the operation of drilling the holes on-site requires skilled workers, and even with skilled installation, might still result in misalignment of the support structure and/or the solar panels supported by that structure.

Misalignment difficulties are exacerbated by the flexing of the panels, as well as sagging permitted by the upper panel support rails. The flexing of the panels and sagging of the upper panel support rails can cause the panels to work out of their holders, whether they would be holding clips or part of the overall structure of the corresponding upper support rail. Improper installation, which occurs frequently in conventional systems, can lead to dislocation of the panels due to sagging or atmospheric conditions. A wide variety of different mounting positions and array arrangements also exacerbate the stability problems caused by panel sagging or deflection. Further, certain mounting positions will make the panels more vulnerable to atmospheric disruptions, such as those created by wind and precipitation. All of these variables also complicate electrical connections to the panels.

The ground-mounted vertical support I-beam and tilt mounting-bracket (14 and 16, respectively, as depicted in FIGS. 1 through 4B) are not the only manner in which an array of solar panels, or other panel-like structures can be mounted. After all, this support arrangement is not always available. Rather, there are many substrates and support systems, such as roofs, upon which solar panels or other panel-like structures can be mounted. However, as previously discussed, the roofs of many structures may not be capable of supporting heavy or elaborate panel support structures. This is particularly crucial since in many locations a roof or roof-like structure is the only support substrate that would be available for a solar panel support structure array.

While the ground-mounted vertical support and tilt mounting-bracket arrangement (14, 16) includes well-known load parameters, the same is not true of many roofs or roof-like structures. These can exhibit a wide variety of different support parameters and other characteristics. Further, most roof-like substrates that are used to support solar cell arrays tend to be flat (providing a level of predictability not found in the use of sloped, i.e. pitched, roofs as panel substrates). Flat roofs are preferred since they avoid the substantial problems of sloped roof mountings.

However, even a stable flat roof presents problems for the mounting of an array of solar panels. In particular, the panels cannot be mounted in the same manner provided using conventional art in FIGS. 1 through 4B of the present application. The stresses that are allowable on a roof structure are far different from those that can be applied to the ground-mounted vertical support beam and tilt mounting-bracket (14, 16) arrangement of FIGS. 1 through 4B. As a result, a whole new set of considerations apply. Foremost among these considerations is the necessity to avoid any damage to the roof while securing panel support structure arrays that can be quite heavy and elaborate.

Also, installation of individual panels can be an expensive and hazardous process. Panel installation constitutes a substantial portion of installation time and thus, installation expense. Even if all difficulties with the support matrix (support joists 13 and mounting rails 15) are eliminated, the problems with panel mounting still remain.

Therefore, a need exists for a low-cost, uncomplicated, structurally strong support system and assembly method, so as to optimally position and easily attach the plurality of photovoltaic panels, while meeting architectural and engineering requirements. Likewise, there is an urgent need for a system that will maintain the security of the mechanical connections of the solar panels to support rails despite the flexing of the panels and support structure caused by any of gravity, vibration, or environmental factors.

At present, none of the conventional art offers these capabilities. An improved support system would achieve a precise panel configuration in the field without extensive work at the installation site. The use of such an improved system would facilitate easy placement of solar panels onto the support structure. Further, a variety of different panel clips or holders could be used within the overall concept of the system. The shipping configuration of the improved support system would be such so as to be easily handled in transit while still facilitating rapid deployment. Installation must be facilitated for a roof or a roof-like structure, providing stable support for the panels without damaging or otherwise compromising the integrity of the roof. Rapid deployment would also include rapid mechanical connection of the panels to panel support rails in a manner that would keep the panels secure despite panel movement due to any number of factors.

### SUMMARY OF THE INVENTION

It is the overall goal of the present invention to provide a dual purpose comprehensive panel mounting system that facilitates rapid, secure installation, including deployment of the panel support structure, placement of the panels on that support structure, and wiring of the panels for activation.

It is a first object of the present invention to improve upon conventional photovoltaic solar panel support systems, especially with regard to layout, assembly and installation, so that the panel array can serve as a roof.

It is another object of the present invention to provide a support and installation system for solar panels in which the panels are less likely to be damaged during installation.

It is a further object of the present invention to provide a support system for solar panels that is easily installed on-site while still resulting in a precise configuration for purposes of mounting the solar panels.

It is an additional object of the present invention to provide a solar panel support system that can be assembled very quickly on site, with little risk to installers or equipment.

It is still another object of the present invention to provide a solar panel support system that can achieve close tolerances during field installation without the necessity of skilled labor at installation.

It is again a further object of the present invention to provide a solar panel support system in which specialized mounting-brackets bonded to the solar panels are not necessary for the mounting of the solar panels to the support system.

It is still an additional object of the present invention to provide a solar panel support system which can be easily adapted to a wide variety of solar panel array sizes and shapes.

It is yet another object of the present invention to provide a solar panel support system which minimizes the necessity for precise measurements at the installation site.

It is still an additional object of the present invention to provide a solar panel support system that can be precisely configured to a specific environment.

It is another object of the present invention to provide a support system for solar panels and other panel-like structures in which degradation caused by metal-to-metal contact is substantially reduced.

It is again another object of the present invention to provide a support system for panel-like structures in which accommodation is made for movement caused by changes in temperatures, humidity or other environmental considerations.

It is still a further object of the present invention to provide a roof interface framework for a solar panel support system.

It is again another object of the present invention to provide a flexible arrangement for using a solar panel support system as a roof or other similar.

It is still an additional object of the present invention to provide a solar panel mounting system that can accommodate easy installation and removal of panels.

It is yet another object of the present invention to provide a roof framework using a solar panel support structure which allows easy installation of adjacent panels, without interfering with previously installed panels.

It is still an additional object of the present invention to provide a collapsible panel support system wherein deployment of the system by rotating support members can be precisely adjusted.

It is still another object of the present invention to provide a roof framework using a panel support system wherein a wide variety of different sizes and shapes of panel configurations can be accommodated, and easily installed, as well as removed.

It is again a further object of the present invention to provide a panel support system which can easily be attached to support brackets without incurring damage to any of the members of the support system.

It is still another object of the present invention to provide a support system for panels or panel-like structures for a wide range of uses, positions, and configurations.

It is again an additional object of the present invention to provide a panel support system in which the relative rotation of structural members to deploy the support system is carefully calibrated and controlled without adjusting or tightening at the installation site.

It is still another object of the present invention to provide a panel support system which can be easily fixed to a fixed mounting system using bolts, without causing damage to structural members of the support system.

It is yet another object of the present invention to provide a panel support system that can be easily deployed or removed by rotating intersecting structural members, without fouling or jamming the rotation devices.

It is again an additional object of the present invention to provide a panel mounting system which facilitates quick, secure mounting of the panels once the support system is deployed.

It is yet another object of the present invention to provide a panel support system that can accommodate flexing, sagging and other deformation of the panels while maintaining a secure connection thereto.

It is yet a further object of the present invention to provide a panel mounting system which facilitates easy electrical connections between the panels.

It is again an additional object of the present invention to provide a panel mounting system that facilitates protection of the electrical wires running from panels mounted thereon.

It is yet another object of the present invention to provide a panel clip or connector that can accommodate flexing of both the panel and the support system.

It is still a further object of the present invention to provide a panel connection system that can facilitate rapid installation while maintaining a secure hold on the panels or panel-like structures.

It is yet an additional object of the present invention to provide support rails configured to ensure a secure panel connection.

It is yet an additional object of the present invention to provide a panel support rail that facilitates protection of long cable runs.

It is still a further object of the present invention to provide wire holders that can be placed in wide range of locations on a panel support rail so as to facilitate both temporary and permanent placement of the wires thereon.

It is again another object of the present invention to provide a panel support system that overcomes the limitations of many conventional structures upon which solar panels might be mounted.

It is yet an additional object of the present invention to provide a panel mounting system wherein multiple purposes can be achieved by the panel support structure, and panels held therein.

It is still another object of the present invention to provide a panel mounting system that avoids wasting real estate by optimizing the panel array and support structure to maximize power output.

It is again another object of the present invention to provide a panel support system to be incorporated in the building design, such as carports, wherein duplicate support structures are avoided.

It is still a further object of the present invention to provide a panel support system in which the panels do not have to be manipulated above the support structure.

It is still a further object of the present invention to provide a panel support system which avoids the use of conventional panel clips, panel holders or the like, so that the process of securing the panels to the panel support structure is accelerated.

These and other goals and objects of the present invention are provided by a structure including a bi-directional panel support system having a plurality of lower support joists and upper panel rails, wherein the upper panel rails include at least one bolt head slot on at least one wall of each of the upper panel rails. The bi-directional panel support system further includes a plurality of L-shaped brackets slideably connectable to a plurality bracket fastener slots. External panels are supported from beneath said panels by the L-shaped brackets connected to the upper panel rails at the bracket fastener slots.

In another embodiment of the present invention, a method for mounting panels on a bi-directional panel support array is used. The array has at least upper panel rails with bolt head slots. The method includes the step of deploying the bi-directional panel support array. L-shaped brackets are placed at predetermined points along the bracket fastener slots by sliding the L-shaped brackets along a predetermined length of the panel rails. Then, panels are placed on the L-shaped brackets and secured to the brackets from below the bi-directional support array.

### BRIEF DESCRIPTION OF THE DRAWINGS

Having generally described the nature of the invention, reference will now be made to the accompanying drawings used to illustrate and describe the preferred embodiments thereof. Further, the aforementioned advantages, and others, will become apparent to those skilled in this art from the following detailed description of the preferred embodiments when considered in light of these drawings, in which:

FIG. 1 is a perspective view of an assembled conventional field ground rack support system for securing a plurality of solar panels;

FIG. 2A is a side view of a conventional tilt bracket mount with prior art C-shaped sectional channels secured back-to-back to form lower support joists to which upper support rails, also shown in FIG. 2B, are secured;

FIG. 2B is an end view of conventional art upper panel rails, each formed by a C-shaped sectional channel;

FIG. 3 is a perspective view of a previously disclosed inventive panel support system as used with the instant invention, including solar panels arranged in a spaced relationship thereon;

FIG. 4A is a top plan view of the bi-directional span of a panel support structure as used in the instant invention, in the open position showing vertically-aligned upper panel rails attached atop lower support joists;

FIG. 4B is an end elevational view of the bi-directional span of the support assembly shown in FIG. 4A with a conventional tilt bracket;

FIG. 5A is a top view depicting a bi-directional panel support structure shown in FIG. 4A, partially collapsed to an intermediate folded position;

FIG. 5B is in enlarged, more detailed top view of the support system in a collapsed or folded position, depicting, in particular, a connector for holding the lower support joist to a support, such as a tilt bracket or similar structure;

FIG. 5C is a side view of FIG. 5B depicting the connector for holding the lower support joist to said support;

FIG. 6 is a side view of a panel roof support structure of the present invention;

FIG. 7 is a top plan view of the structure depicted in FIG. 6;

FIG. 8 is an end view of a single panel held by two support rails in accordance with the structure of the present invention; and

FIG. 9 is a bottom perspective view depicting details of the panel rail and L-bracket.

### DESCRIPTION OF THE PREFERRED EMBODIMENTS

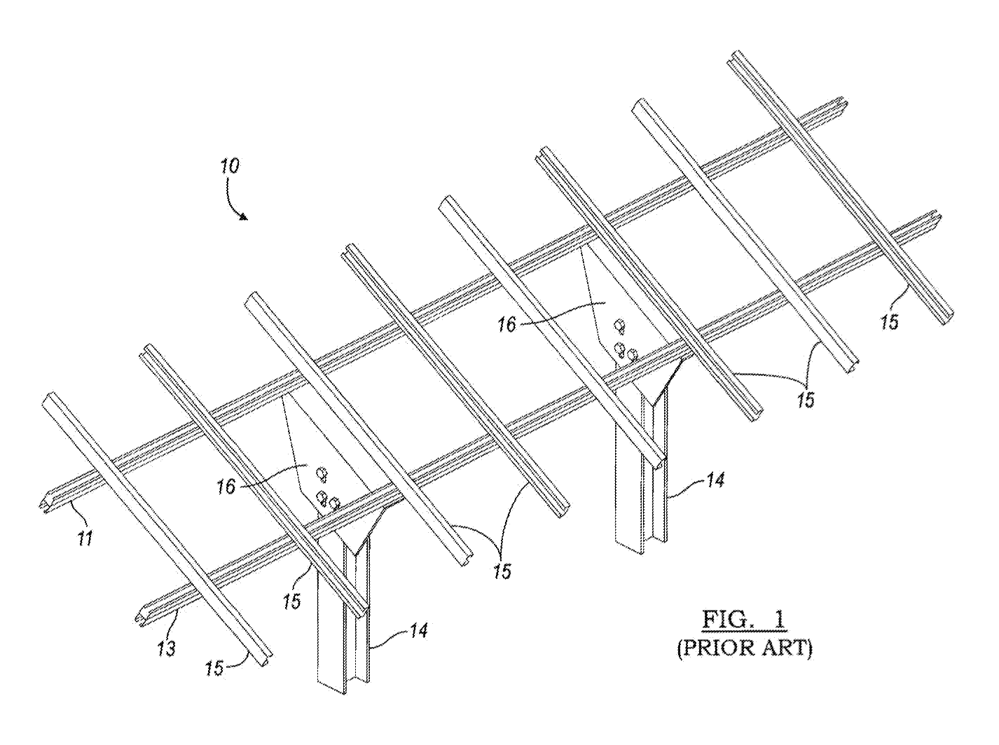

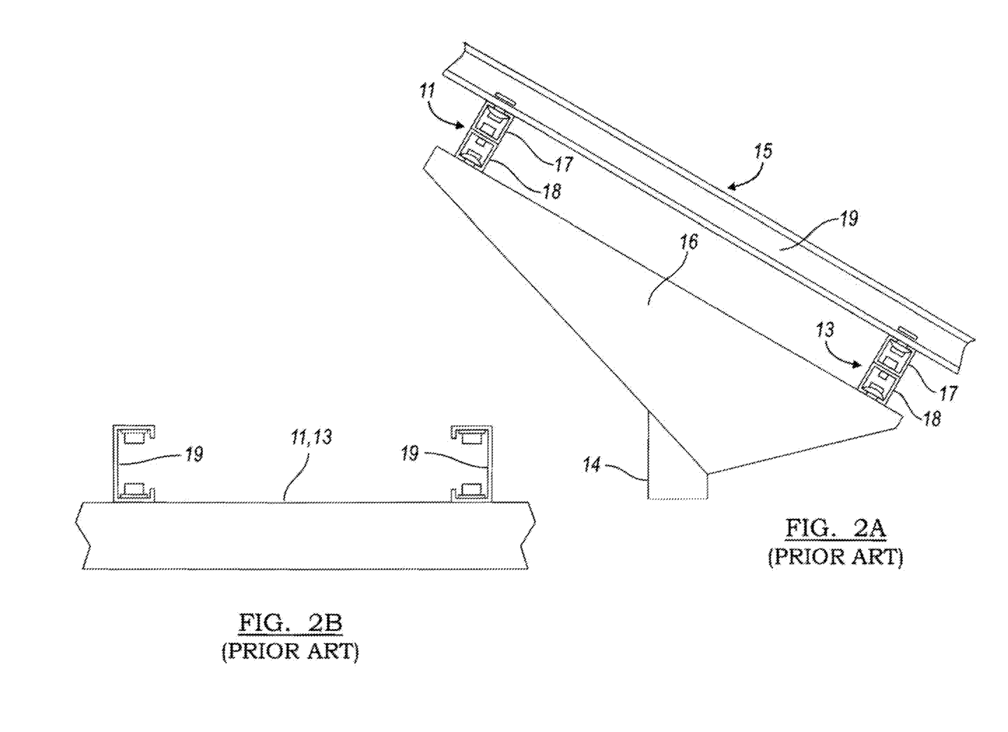

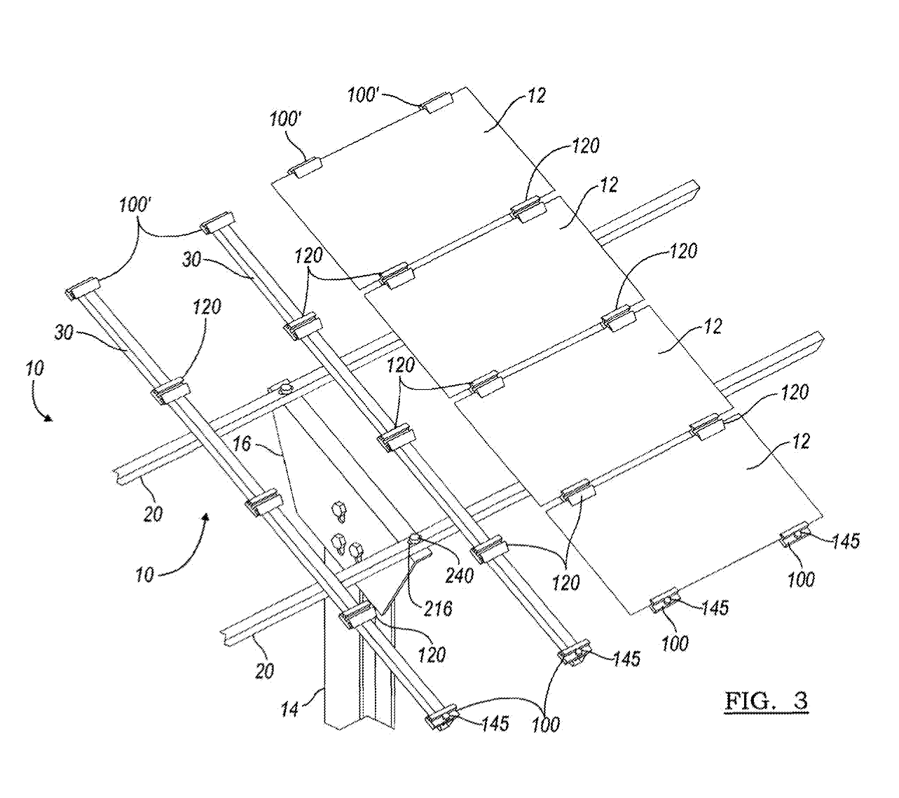

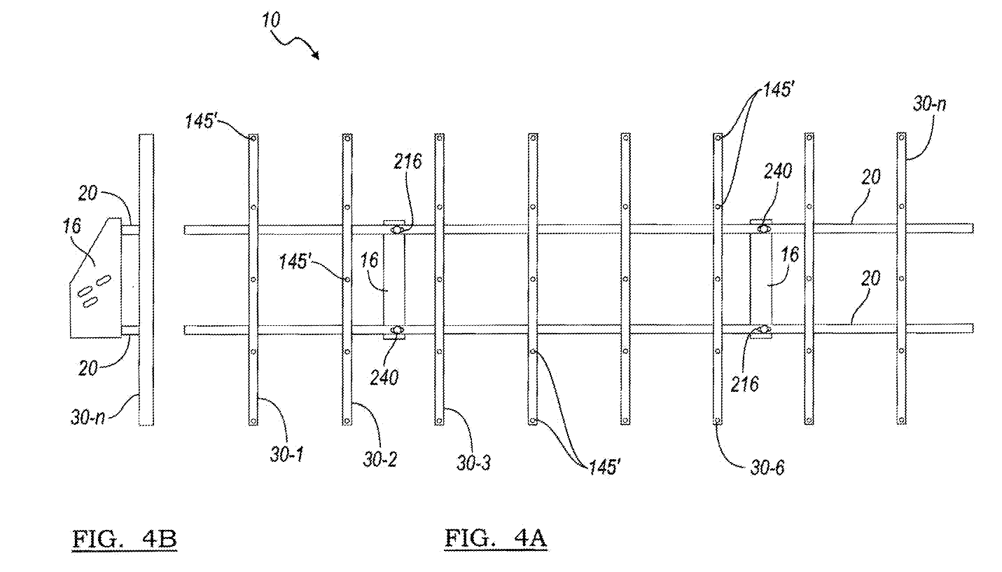

The present invention is used in the conventional environment depicted in FIGS. 1-2B, and is an improvement upon the previously disclosed inventions depicted in FIGS. 3-5C. The previously disclosed inventions by common inventors are found in U.S. patent application Ser. Nos. 12/383,240 (filed Mar. 20, 2009); 12/567,908 (filed Sep. 23, 2009); 12/686,598 (filed Jan. 13, 2010); 13/115,506 (filed May 25, 2011); 61/414,963 (filed Nov. 18, 2010); and 61/539,653 (filed Sep. 27, 2011). All of these patent applications describe prior inventive structures that can be used with the present invention. The present patent application relies on all three for priority, and incorporates all by reference for purposes of providing a more complete background for the instant invention.

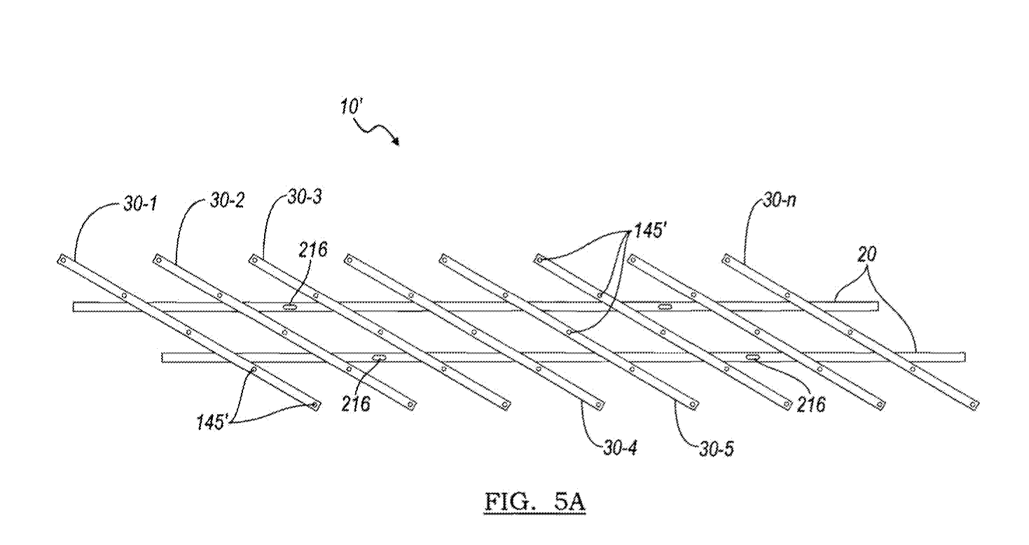

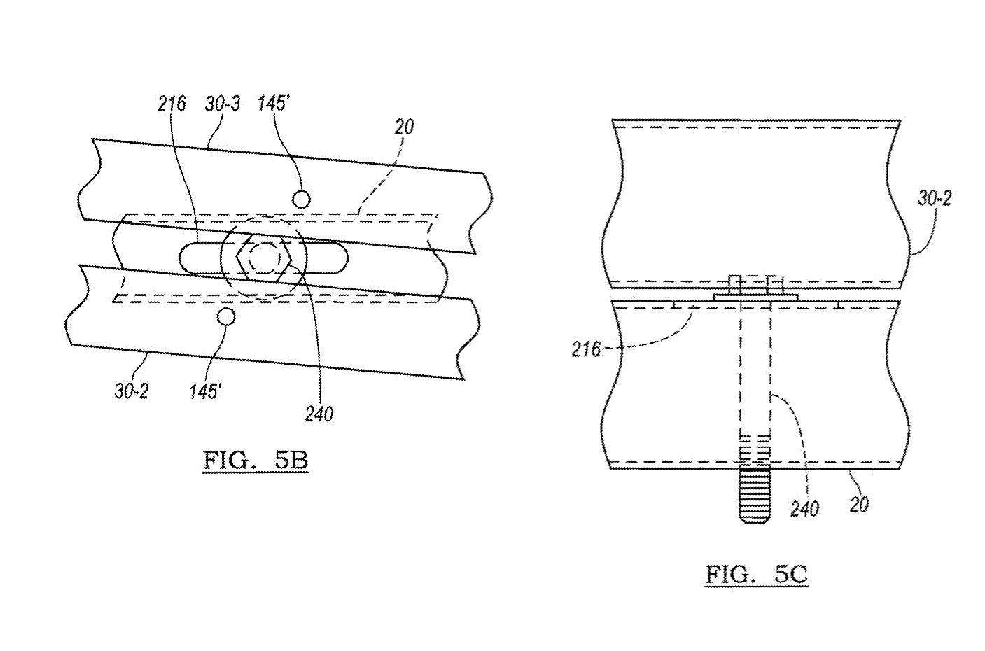

Drawings 3-5C are relied upon as disclosing a panel support system matrix or array 10 constituted by lower support joists 20 and upper panel rails 30. The support system matrix 10 is foldable as a complete unit as depicted in FIG. 5A, and detailed views at FIGS. 5B and 5C. The foldable panel support system matrix 10 facilitates the installation of the present invention since the panel support system matrix 10 can be pre-measured, pre-drilled and assembled at the factory. The support system matrix 10 is then folded for shipment and deployed for onsite installation.

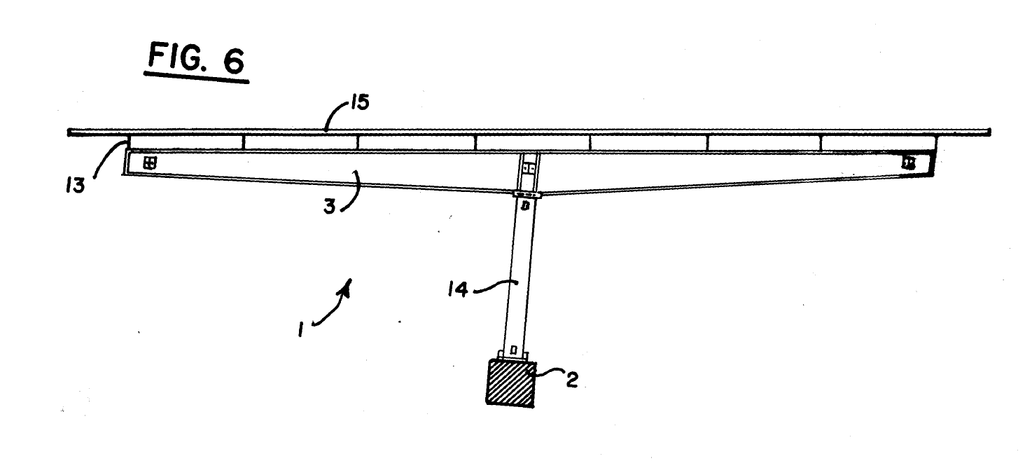

It should be understood that a wide variety of different support system matrix 10 arrangements can be used with the panel/roof support structure of the present invention. For example, a panel support system matrix 10 such as that depicted in FIGS. 1 and 2 can be used instead of the panel support system matrices 10 of FIGS. 3-5C. Likewise, any of the panel support system matrices 10 depicted in the aforementioned patent applications incorporated by reference can also be used in conjunction with the present invention. Any number of different styles of panel support system matrix 10 can be used with the present invention as depicted in FIGS. 6-8. However, the first preferred embodiment of the present invention includes a panel support system matrix 10 that is foldable into a pre-assembled configuration.

The panel support system matrix 10 is merely one component of the overall panel roof support structure depicted in FIGS. 6-8. The support structure 1 is meant to be placed on the ground using a foundation 2 which interfaces with the ground or other firm foundational substrate. In one preferred embodiment, the foundation piece 2 is concrete and can be arranged in any number of configurations suitable for the weight of the rest of the structure to be supported.

In the first preferred embodiment depicted in FIGS. 6-8, a single upright support 14 is used on each side of the support structure 1. Preferably, upright support 14 is an I-beam. However, any type of suitable upright support can be used. Each upright support 14 supports a structural beam 3. The interface between upright support 14 and structural beam 3 can be any arrangement considered appropriate for connecting structural steel. While the arrangement of vertical support 14 and structural beam 3 is preferably as depicted in FIG. 6, other arrangements, vertical supports and structural beams can be used. For example, the free-field ground rack system (14, 16) of FIGS. 1-3 could also be used, depending upon the size and other characteristics of the completed structure.

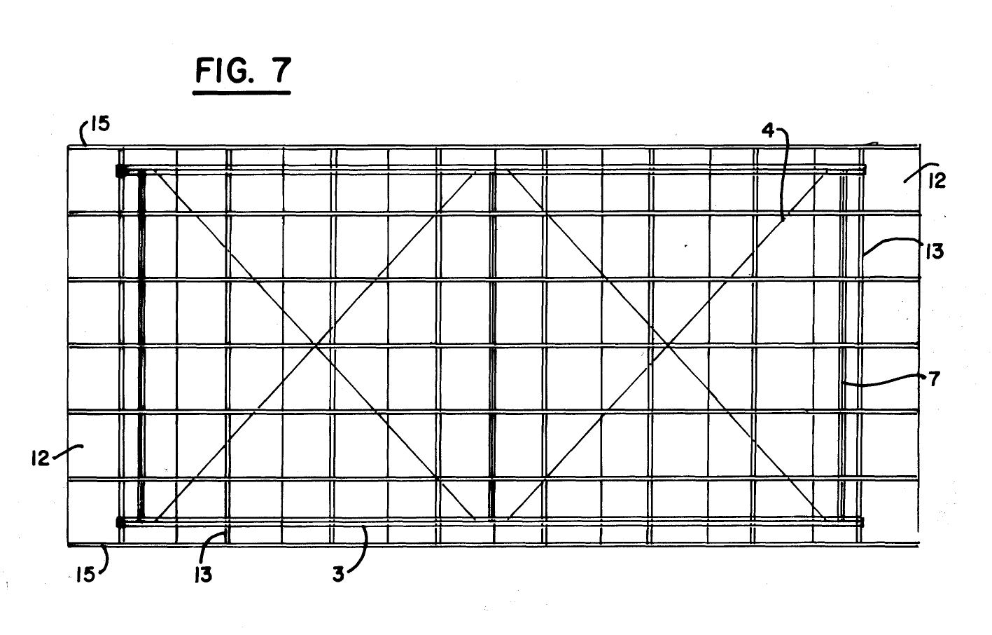

As depicted in the drawings, there are preferably two vertical supports 14, each supporting a structural beam 3. A panel support matrix (i.e., support joists 13 and modified panel rails 15) spans the two structural beams 3 as depicted by the top view of FIG. 7. The panel support matrix is constituted by lower support joists 13 and upper panel rails 15 (to hold panels 12), arranged perpendicular to support joists 13. The lower support joists 13 span the two structural beams 3. The length of the lower support joists 13 can extend beyond the area encompassed between the two support beams 3, as indicated in FIG. 7, and in FIGS. 1 and 3. The amount by which lower support joists 13 extend beyond structural beams 3 depends upon the strength of lower support joists 13, and the overall load provided by both the upper panel rails 15 and panels 12. The panel support system array (support joists 13 and modified panel rails 15) can also be designed for heavier loads by reducing the spacing between support joists 13. Another alternative is to provide a more robust lower support joist 13, such as the tubular configurations disclosed in the cited patent applications (designated lower support joist 20).

In FIG. 6, lower support joists 13 are C-channels. However, any support member that will facilitate a folding configuration (as disclosed in the cited patent applications) can be used. A folding panel support system configuration 10 (support joists 13 and panel rails 15) are an important part of the present invention since this configuration facilitates pre-assembly, easy shipping, and rapid and accurate deployment. One major object of the preferred embodiment in this case is the rapid and accurate deployment of the panel support system. Another principal objective is the rapid, easy and secure installation and attachment of panels 12 to the deployed system.

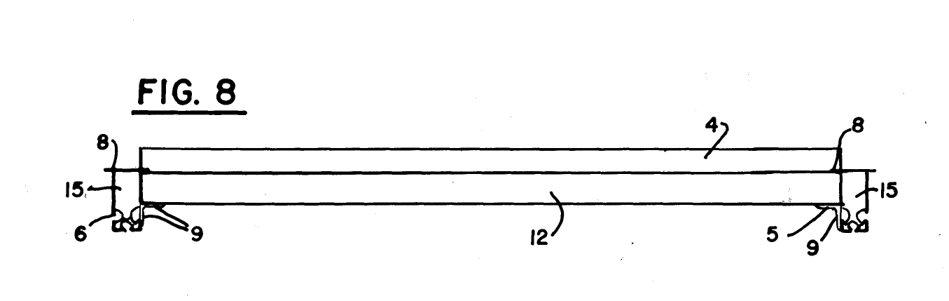

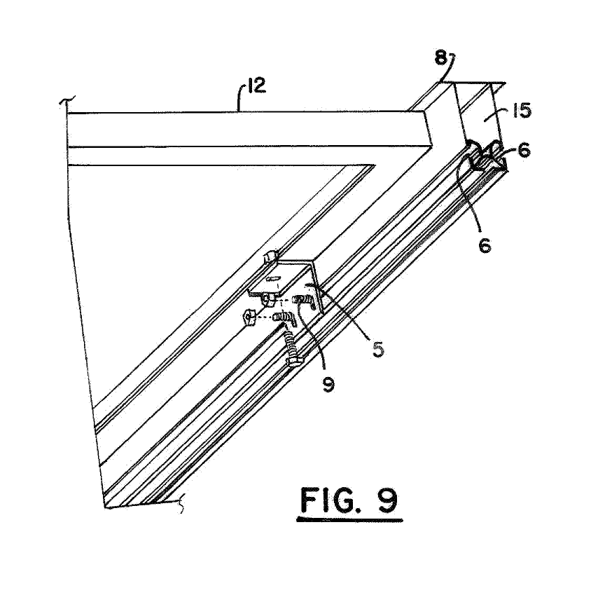

The upper panel rails 15 for the present invention are designed to accommodate the sliding of panels 12 along the length of the upper panel support rails, and the rapid tightening of the panels 12 into position. FIG. 8 depicts an end view, or cross-sectional view of upper panel rail 15, which shows the functional attributes necessary for the present invention. Each upper panel rail 15 has a flange 8 which extends beyond the sidewall and along the length of upper panel rail 15. This flange is used to hold the top of panel 12 in position. The bottom portion of upper panel rail 15 has a configuration of triple T-slots 6. The slots are used to hold the top of connecting bolts 9. The T-slots 6 can also be used to hold wiring, wiring trays or grommets as disclosed in the cited patent applications.

For purposes of the present invention an important use of the T-slot channels 6 is to hold L-brackets 5 in position to support panels or panel modules 12 from beneath. Because the T-slot channels 6 run the entire length of upper panel rail 15, it is possible for the L-brackets 5 to be moved to any position along the length of the panel rail 15 to provide support for the panels or panel modules 12 at desired locations.

The panels 12 are of the framed variety, often referred to as panel modules. Because each panel 12 is framed, connectors 9 can be driven into the surrounding frames to hold each panel 12 in place without compromising or otherwise affecting the panel itself. This is especially important when solar panels are being used, rather than mere structural panels such as those used to cover an enclosure. When panel modules are used, the flange 8 will extend only over the outer perimeter framework, and not block any part of the active solar panel 12. The flanges 8 will position the solar panels 12 in place from above facilitating connection and adjustment by the installer from below.

Because the T-channel 6 is found on either side of the panel rail 15, the mounting of adjacent panels 12 is easily facilitated. Likewise, the mounting of auxiliary devices (not shown) using the T-channels 6 is facilitated by the triple-channel arrangement. Even the T-channel 6 that is used for L-bracket 5 can be used to mount auxiliary devices since the L-bracket 5 is the only support beneath panel 12 and occupies very little room along the length of panel 15. The L-bracket 5 extends only as far as the outer perimeter framing (not shown) of the solar panel module 12. Consequently, this bracket will not interfere with any portion of the active solar panel 12. Wiring nuts and wire trays such as those disclosed in the cited patent applications, can be used with the same T-channels 6 that support the L-brackets 5. This feature facilitates secure wiring, either in wiring nuts or by running wiring within the T-channels 6 themselves.

A chief benefit of the present invention is that it facilitates a process of rapid assembly of panels 12 within the support matrix (i.e., support joists 13 and modified panel rails 15) of the structure depicted in FIGS. 6 and 7. The panels or panel modules 12 are put into place from the bottom exclusively. This is possible because the L-brackets 5 are used to hold panel 12 from beneath. The capability of L-bracket 5 to be slid along the entire length of upper panel rail 15 allows additional temporary support to be used wherever needed. It also facilitates the placement of the panels 12 from almost any position beneath the panel support matrix (support joists 13 and panel rails 15).

Further, the present invention permits the “feeding” of the panels from one end of the panel support matrix along a stretch of upper panel rails 15 by sliding the panels 12 under the flanges 8 and using temporary L-brackets 5 wherever appropriate beneath the panels. As a result, panels 12 can be placed quickly and easily without the use of highly skilled installers. Further, since there is no longer the necessity for installers to operate from above the panel support matrix, the overall installation process is much safer than conventional approaches. The sliding L-brackets 5 provide both speed and versatility while simplifying the mechanical connections. Installation from beneath, using virtually any kind of panel, is a major benefit of the present invention.

Another benefit of the present invention is that the same support structure (as depicted in FIGS. 6-8) can be used to support the roof of an enclosure, as well as an array of solar panels. This means that a single structural arrangement can be used for both a building and a panel support array. Because framed solar panels 12 are being used, they can be fit tightly together so as to provide roof-like qualities. As a result, additional space is not needed for a solar array when using the present invention for, as an example, a carport, bus stop enclosure, patio, shaded shelter, gazebo, or other roofed structure. Because of the strength of upright supports 14 and structural beams 3, a wide variety of different buildings and other structures can be supported thereby. This saves the expenditure of both land and additional money that would be used for multiple structural arrangements to support both the building and separate solar array. Because of the use of structural beams 3, subsidiary structures (not shown) can be added beneath the panel support structure matrix (13, 15).

Because of the overall weight of the panel support structure matrix (13, 15), panels 12, and possible extensions beyond the structural beams 3, diagonal cross-supports 4 (as depicted in FIGS. 7 and 8) are sometimes appropriate. Diagonal cross-supports 4 can be arranged above or below the panels 12. Preferably, the diagonal cross-supports 4 are arranged above the panels 12. Therefore, this arrangement does not hinder the maneuvering of the panels since they are installed from below the support matrix (13, 15). Further, because panels 12 are installed from beneath the support matrix (13, 15), additional subsidiary structures (not shown) can be installed without interfering with the solar panels 12.

As depicted in FIG. 7, perpendicular cross-supports 7 can also be used to facilitate additional rigidity between the two parallel support beams 3. Still further, a wide variety of different bracings and affiliated structures can be used with the support arrangement 1 of the present invention. The only requirement is that bottom access to the support array not be hindered by additional structures until the panel modules 12 have been put into place and fastened. The Appendix “A” discloses details of installation of panel modules 12, using only access from below.

While a number of embodiments and variations of the present invention have been described by way of example, the present invention is not limited thereto. Rather, the present invention should be understood to include any and all variations, modifications, adaptations, derivations, and embodiments that would occur to one skilled in this art in possession of the teachings of the present invention. Accordingly, the present invention should be construed to be limited only by the following claims.

We claim:

1. A structure including a bi-directional panel support system having a plurality of lower support joists and upper panel rails, wherein each of said upper panel rails comprise at least one bolt head slot on at least one sidewall of each said upper panel rail, and said bi-directional panel support system further comprising:
a) a plurality of L-shaped brackets slideably connectible to a plurality of said bolt head slots, wherein external panels are supported from beneath and secured by said plurality of said L-shaped brackets connected to said upper panel rails at said bolt head slots.

2. The structure of claim 1, wherein said bi-directional panel support system is foldable and deployable as a single unit.

3. The structure of claim 2, wherein said structure comprises an enclosure roof.

4. The structure of claim 2, wherein said upper panel rails further comprise a bolt head slot on a bottom surface of each said upper panel rail to comprise a bolt to form a slideable and rotational connection to one of the underlying support joists.

5. The structure of claim 1, wherein said at least one bolt head slot comprises an arcuate T-shaped cross-sectional shape.

6. The structure of claim 2, wherein said L-shaped brackets comprise apertures for facilitating a connection to one of said supported external panels.

7. The structure of claim 6, wherein said supported external panels comprise photovoltaics.

8. The structure of claim 7, further comprising a structural support arrangement interfacing with an underlying substrate, and supporting said bi-directional panel support system.

9. The structure of claim 8, wherein said structural support system comprises steel and concrete, and said bi-directional panel support system comprises steel lower support joists and aluminum upper panel rails.

10. The structure of claim 9, wherein said bi-directional panel support system further comprises separators arranged between lower support joists and said upper panel rails.

11. The structure of claim 10, wherein said separators comprise nylon bushings arranged at bolt connections between said lower support joists and said upper panel rails to facilitate ease of rotateability of said bi-directional panel support system.

12. The structure of claim 5, wherein said upper panel rail having the bolt head slot comprises at least one flange at a top surface of said upper panel rail, said flange extending beyond the slotted sidewall of said upper panel rail.

13. A method of mounting panels on a bi-directional panel support array having at least upper panel rails with each upper panel rail having a bolt head slot, said method comprising the steps of:
a) deploying said bi-directional panel support array;
b) placing L-shaped brackets at predetermined positions along a length of each bolt head slot by sliding said L-shaped brackets along said length for each of said upper panel rails; and
c) placing each of said panels on selectively positioned L-shaped brackets, and securing each of said panels to said selected L-shaped brackets from below the bi-directional panel support array.

14. The method of claim 13, wherein the step of deploying the bi-directional panel support array comprises the step of securing said bi-directional panel support array to a substrate support structure.

15. The method of claim 14, wherein the step of deploying said bi-directional panel support array further comprise the sub-step of unfolding said bi-directional panel support array as a unit from a folded transport position.

16. The method of claim 15, wherein said panels are configured to constitute a roof structure of a carport.

17. The method of claim 16, wherein said panels are photovoltaic devices.

18. The method of claim 17, further comprising the steps of:
d) placing wiring devices in said bolt head slots; and
e) wiring said photovoltaic panels using said wiring devices.

19. The method of claim 13, wherein step (c) further comprises the substep of sliding each of said panels between said corresponding selectively positioned L-shaped brackets and an upper flange on said corresponding upper support rail.
